(19) United States
(12) Patent Application Publication
(10) Pub. No.: US 2011/0202920 A1
(43) Pub. Date: Aug. 18, 2011

(54) APPARATUS AND METHOD FOR COMMUNICATION PROCESSING

(75) Inventor: Masaaki TAKASE, Kawasaki (JP)

(73) Assignee: FUJITSU LIMITED, Kawasaki-shi (JP)

(21) Appl. No.: 13/023,535

(22) Filed: Feb. 8, 2011

(30) Foreign Application Priority Data
Feb. 17, 2010 (JP) 2010-032042

(51) Int. Cl. G06F 9/455

(52) U.S. Cl. 718/1

(57) ABSTRACT

A method includes: judging whether or not a destination address of a received message is a predetermined address of a first virtual switch being operating; upon judging that the destination address of the received message is the predetermined address of the first virtual switch, converting the destination address of the received message to a broadcast address to virtual machines that are under the first virtual switch and belong to the same subnet as a subnet to which the first virtual switch belongs; and outputting a message after the conversion.

### CROSS-REFERENCE TO RELATED APPLICATIONS

This application is based upon and claims the benefit of priority of the prior Japanese Patent Application No. 2010-032042, filed on Feb. 17, 2010, the entire contents of which are incorporated herein by reference.

### FIELD

This technique relates to a communication processing technique between plural virtual machines (VM) that are operating on a physical server.

### BACKGROUND

In an environment, such as in cloud computing, in which physical resources are shared by plural customers (also called tenants), the logical separation between customers is realized as a system. More specifically, it is carried out to prevent a customer from receiving communication contents for another customer, and prevent access to resources being used by another customer.

For example, an environment such as illustrated in FIG. 1 is presumed. In the environment in FIG. 1, tenants A and B (customers A and B) share physical servers A and B and a physical layer 2 switch (notated as physical L2SW below). In addition, in the physical server A, virtual machines VM1 and VM2, and virtual L2SW_1 and virtual L2SW_2 of the virtual layer 2 switch (notated as virtual L2SW) operate, where virtual machine VM1 and virtual L2SW_1 are logical resources of the tenant A. Moreover, virtual L2SW_2 and virtual machine VM2 are logical resources of the tenant B. On the other hand, in the physical server B, virtual machines VM3 and VM4, and virtual L2SW_3 operate, where virtual machines VM3 and VM4, and virtual L2SW_3 are logical resources of the tenant A. Furthermore, the physical servers A and B are connected each other via the physical L2SW. The layer 2 addresses (notated as a L2 address, or more specifically as a MAC (Media Access Control) address) of the respective virtual machines are added such that they do not overlap.

Here, when the virtual machine VM1 of the tenant A transmits a broadcast message, “FF:FF:FF:FF:FF:FF” is set as the MAC address of the destination in that message. This address is a reserved address and is common in all networks. Therefore, when the virtual LSW_1 receives such a broadcast message, the virtual LSW_1 outputs that message to the physical L2SW. When there are no restrictions, the physical L2SW receives the broadcast message and outputs a broadcast message to not only the virtual L2SW_3 on the physical server B, which belongs to the same tenant A, but also to the virtual L2SW_2, which belongs to the different tenant B. In other words, the contents of the broadcast message are leaked.

Generally, the server virtualization technique for sharing the physical server and virtual LAN (VLAN) technique for sharing a network are used. The VLAN technique is widely used, and there is no problem as long as the system is on scale in which this technique can be used. However, the number of VLAN-IDs that can be used is set at 4,094, which may be insufficient in a large-scale cloud system.

Incidentally, when a virtual machine is generated and the virtual machine requests to assign a new IP address using the Dynamic Host Configuration Protocol (DHCP) method, that virtual machine does not know the location of the DHCP server. Therefore, the virtual machine carries out the broadcast. Therefore, after broadcast packets are also sent up to a network level in each of the other computers that are connected to the network and the other computers use CPU resources for the broadcast packet, it is finally judged that this broadcast packet is not for the computer itself. During this processing, other processes on that computer are influenced. However, on the physical machine on which that virtual machine is generated, the location of the DHCP server may already be known due to the broadcast from another virtual machine that has already been generated and activated. Thus, there is a document that discloses a problem wherein, when plural virtual machines are generated on a host (i.e. physical machine) on a network in this way, the address of the DHCP server is known from a virtual machine that was generated and activated previously, the broadcast from a virtual machine that is generated and activated afterwards on that host is redundant. Therefore, a solution has been proposed in which a DHCP address acquisition request, which is primarily a local broadcast, is converted to a unicast to the DHCP server without broadcasting on a hypervisor. However, because this is the DHCP address acquisition request, after the request has reached the DHCP server, it is not necessary to transfer that request to other servers.

Moreover, for a virtual local area network, there is also a technique for suppressing flooding in a relay network. In this technology, the edge transfer apparatus executes: receiving a MAC frame from a subscriber local area network via that subscriber port; identifying a service VLAN identifier that corresponds to the received MAC frame from the subscriber port that received that MAC frame; acquiring a destination group identifier for identifying the transmission source of the MAC frame and a set of one or plural destinations; judging, based on the acquired destination group identifier, whether or not there is one or more of relay ports that can transfer the MAC frame; generating a relay MAC frame that includes at least a MAC frame and service VLAN identifier, when it was judged that there is one or more relay ports that can transfer the MAC frame; attaching the destination group identifier to the relay MAC frame; and transferring the relay MAC frame, to which the destination group Identifier was attached, to one or more relay ports. However, this presumes a VLAN.

As described above, it is difficult to achieve plural subnets that exceed the VLAN restriction with one system.

In other words, the conventional art cannot logically separate plural subnets that share physical resources.

### SUMMARY

A communication processing method relating to a first aspect includes: judging whether or not a destination address of a received message is a predetermined address of a virtual switch executing this communication processing method; when it is judged that the destination address of the received message is the predetermined address of the virtual switch, converting the destination address of the received message to a broadcast address to virtual machines that are under the virtual switch and belong to the same subnet; and outputting a message after the conversion.

A communication processing method relating to a second aspect includes: (A) calculating, for each of subnets satisfying a predetermined condition, an evaluation value for the frequency of copies from the number of broadcast messages within unit time and the number of virtual switches belonging to the same subnet, which are stored in a data storage unit; (B) sorting the subnets in descending order of the evaluation value, assigning an identifier of a virtual local area network (VLAN) to each of a top predetermined number of subnets, and setting a VLAN mode to first virtual switches belonging to the top predetermined number of subnets; and (C) setting an address conversion mode to second virtual switches belonging to subnets other than the top predetermined number of subnets, wherein, in the address conversion mode, a broadcast message is converted to a unicast message to virtual switches belonging to the same subnet and a received unicast message to the second virtual switch is converted to a broadcast message to virtual machines under the second virtual switch.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting a problem of a conventional system;

FIG. 2 is a diagram depicting a system outline relating to a first embodiment of this technique;

FIG. 3 is a functional block diagram of a virtual layer 2 switch;

FIG. 4 is a diagram depicting an example of data held in a private SW data storage area;

FIG. 5 is a diagram depicting an example of data held in a conversion table storage area;

FIG. 6 is a diagram depicting an example of data held in a transfer table storage area;

FIG. 7 is a diagram depicting a processing flow relating to the first embodiment;

FIG. 8 is a diagram depicting an example of data (in an address conversion mode) held in the conversion table storage area;

FIG. 9 is a diagram depicting an example of data (in a VLAN mode) held in the conversion table storage area;

FIG. 10 is a schematic diagram depicting an operation in the VLAN mode;

FIG. 11 is a schematic diagram of a system relating to a third embodiment;

FIG. 12 is a functional block diagram of a resource management apparatus;

FIG. 13 is a diagram depicting an example of data stored in a physical resource data storage unit;

FIG. 14 is a diagram depicting an example of data stored in a logical resource data storage unit;

FIG. 15 is a diagram depicting an example of data stored in the logical resource data storage unit;

FIG. 16 is a diagram depicting an example of data stored in the logical resource data storage unit;

FIG. 17 is a diagram depicting an example of data stored in the logical resource data storage unit;

FIG. 18 is a diagram depicting an example of data stored in a tenant data storage unit;

FIG. 19 is a diagram depicting an example of data stored in the tenant data storage unit;

FIG. 20 is a diagram depicting an example of data stored in a transfer table storage unit;

FIG. 21 is a diagram depicting an example of data stored in a conversion table storage area;

FIG. 22A is a diagram depicting a processing flow of the virtual L2SW in the third embodiment;

FIG. 22B is a diagram depicting a processing flow of the virtual L2SW in the third embodiment;

FIG. 23 is a diagram schematically depicting a processing when an APR request is received;

FIG. 24 is a diagram schematically depicting a processing for a unicast message;

FIG. 25 is a diagram depicting a processing flow of a measurement processing of a broadcast transfer amount;

FIG. 26 is a diagram depicting a processing flow of a processing executed by the resource management apparatus;

FIG. 27 is a diagram depicting a processing flow of a processing when VM is deployed;

FIG. 28 is a diagram depicting a processing flow of a VLAN-ID assignment determination processing;

FIG. 29 is a diagram depicting a processing flow of a processing for a VM deletion request;

FIG. 30 is a diagram depicting a processing for a broadcast transfer amount change notification;

FIG. 31 is a diagram depicting a processing flow of a processing executed by the virtual switch relating to the embodiments;

FIG. 32 is a diagram depicting a processing flow of a processing executed by a resource management apparatus relating to the embodiments;

FIG. 33 is a functional block diagram of a computer relating to the embodiment;

FIG. 34 is a diagram block diagram of a computer relating to the embodiments; and

FIG. 35 is a functional block diagram of a computer.

### DESCRIPTION OF EMBODIMENTS

### Embodiment 1

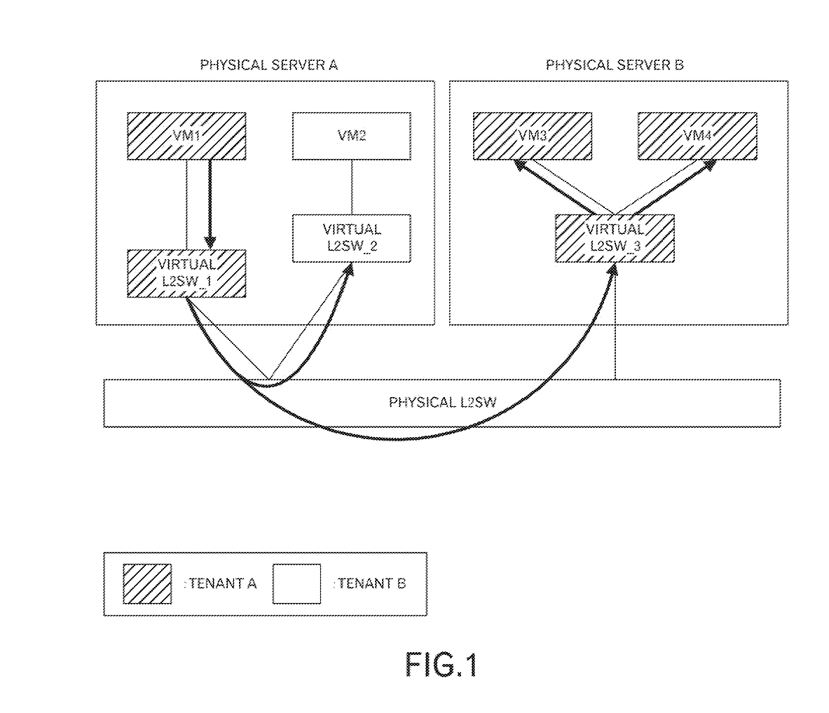

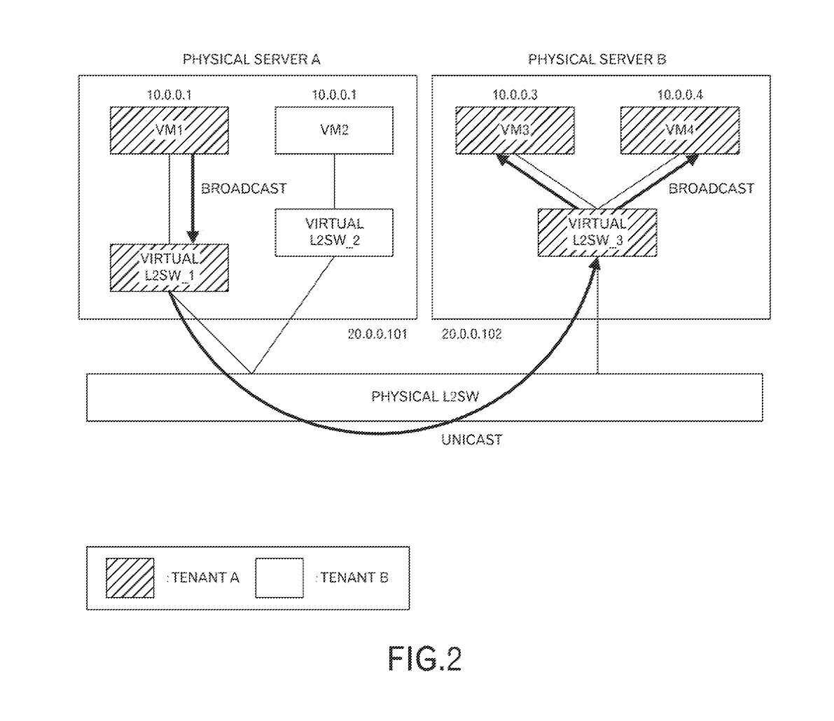

FIG. 2 illustrates a system overview relating to a first embodiment of this technique. In the example in FIG. 2, as in FIG. 1, tenants A and B (i.e. customers A and B) share the physical servers A and B and the physical layer 2 switch (i.e. physical L2SW). Then, on the physical server A, the virtual machines VM1 and VM2, and the virtual L2SW_1 and virtual L2SW_2, which are the virtual L2SW, are operating, where the virtual machine VM1 and virtual L2SW_1 are logical resources of the tenant A. Also, the virtual L2SW_2 and virtual machine VM2 are logical resources of the tenant B. On the other hand, on the physical server B, the virtual machines VM3 and VM4, and the virtual L2SW_3 are operating, where the virtual machines VM3 and VM4, and virtual L2SW_3 are logical resources of the tenant A. Furthermore, the physical servers A and B are connected to each other by the physical L2SW. The layer 2 addresses of the virtual machines (more specifically, the MAC addresses) are assigned so that they do not overlap. On the other hand, the IP addresses can be freely assigned for each tenant. Therefore, because the tenants are different, the same IP address is given the virtual machine VM1 and virtual machine VM2 on the physical server A. In addition to the virtual machines, IP addresses (for example, 20.0.0.101 and 20.0.0.102) are given to the physical servers A and B as well.

In this embodiment, by applying the configuration described below to the virtual L2SW, a broadcast message is prevented from being sent to virtual machines of a different tenant without using a VLAN. More specifically, a virtual MAC address is given to the virtual L2SW in advance, and virtual MAC addresses for virtual L2SWs other than its own virtual L2SW are registered in the virtual L2SWs that belong to the subnet of the same tenant. In the example in FIG. 2, a virtual MAC address such as 00:50:00:00:50:01 is given to the virtual L2SW_1 that belongs to the subnet of the tenant A, and a virtual MAC address such as 00:50:00:00:50:03 is assigned to the virtual L2SW_3. Furthermore, a virtual MAC address such as 00:50:00:00:50:02 is given to virtual L2SW_2 that belongs to the subnet of tenant B. Moreover, in the case of the virtual L2SW_1, the virtual MAC address of the other virtual L2SW_3 of the tenant A is kept, and in the case of virtual L2SW_3, the virtual MAC address of the other virtual L2SW_1 of the tenant A is kept. Incidentally, as for the virtual L2SW_2, there is no other virtual L2SW for the tenant B so there is no virtual MAC address for the other virtual L2SW to be kept for the main processing in this embodiment.

Next, as in FIG. 1, a broadcast message is presumed to be output from the virtual machine VM1 of the tenant A. A broadcast address, which is a reserved address, is set in this broadcast message, and when the virtual L2SW_1 receives this message, the virtual L2SW_1 recognizes that the broadcast address is set as the destination MAC address, and replaces the broadcast address with the virtual MAC address of another virtual L2SW that belongs to the same subnet. In the example in FIG. 2, the broadcast address is replaced with the virtual MAC address of the virtual L2SW_3. Incidentally, when the virtual MAC addresses for plural virtual L2SWs are kept, the received message is copied (the number of virtual L2SWs−1) times, and the destination MAC address of each message is replaced with each of the virtual MAC addresses. In other words, the broadcast message is converted to the unicast message. Then, the message is outputted to the upper-level L2 switch (the physical L2SW in FIG. 2). Incidentally, in the example in FIG. 2, there is no virtual machine other than the virtual machine VM1 connected to the virtual L2SW_1, however, in the case that another virtual machine were connected, the broadcast message is outputted to the other virtual machines in the same way as a normal broadcast message.

The physical L2SW, as in the case of the where a normal unicast is received, outputs the received message to an apparatus to which a device having the destination MAC address (=virtual MAC address) is connected. In the case in FIG. 2, the message is outputted to the physical server B. In the physical server B, the virtual L2SW_3 is identified from the virtual MAC address, and the message is outputted to the virtual L2SW_3.

After receiving a message addressed to its own virtual MAC address, the virtual L2SW_3 recognizes that the received message is the broadcast message, and after replacing the destination address with the broadcast address, the virtual L2SW_3 outputs the received message to the subordinate virtual machines VM3 and VM4.

By carrying out such a processing, the output of the broadcast message to the virtual L2SW_2 for other tenants is eliminated without using the VLAN. In other words, the logical separation between subnets is adequately realized.

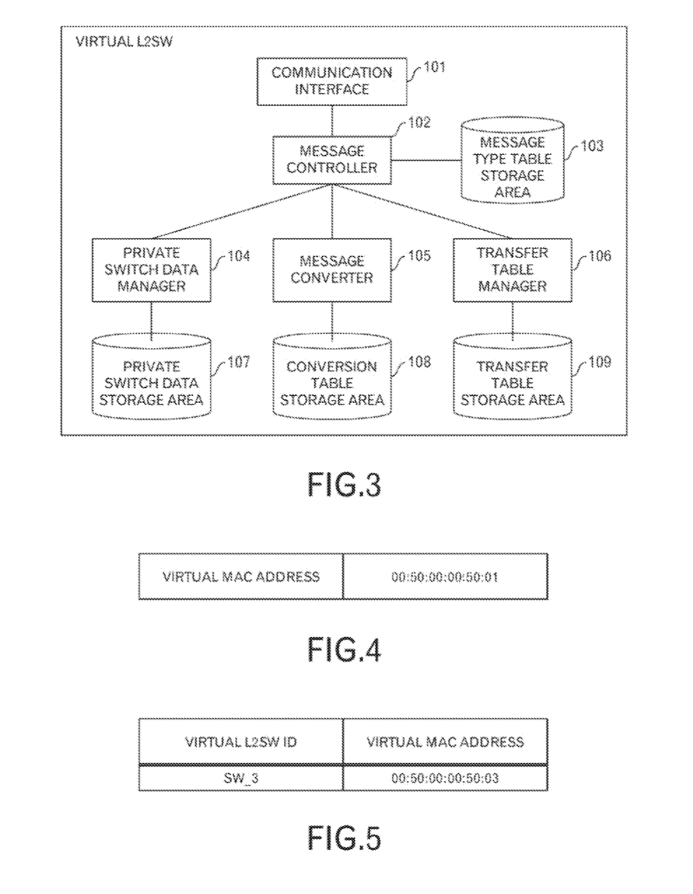

Next, the configuration of the virtual L2SW is explained using FIG. 3. The virtual L2SW is a program that, when executed by a physical server, operates as an L2 switch, and includes: a communication interface (IF) 101 that carries out communication with virtual machines, other virtual L2SW, an operating system (OS) of the physical server and the like; a message controller 102 that carries out a control processing for messages received by the communication IF 101; and a private switch data manager 104 that cooperates with the message controller 102 to carry out a processing for managing the data in the L2SW's own virtual switch (SW). The virtual L2SW also includes: a message converter 105 that cooperates with the message controller 102 to carry out a message conversion processing; and a transfer table manager 106 that cooperates with the message controller 102 to carry out a processing for managing a transfer table.

A message type table storage area 103 is an area that is used by the message controller 102, and holds data to identify the message type. In this embodiment, for example, this area is an area where data is stored for determining whether or not the received message is a broadcast message, and where a broadcast address is stored, for example.

Moreover, a private switch data storage area 107 is an area that is used by the private switch data manager 104, and stores data such as illustrated in FIG. 4. In the example in FIG. 4, the data is its own switch data for the virtual L2SW_1, and includes a virtual MAC address.

Furthermore, a conversion table storage area 108 is an area that is used by the message converter 105, and stores data such as illustrated in FIG. 5. In the example in FIG. 5, this table is a conversion table for the virtual L2SW_1, and is a table where the virtual MAC addresses for other virtual L2SWs that belong to the same subnet are registered.

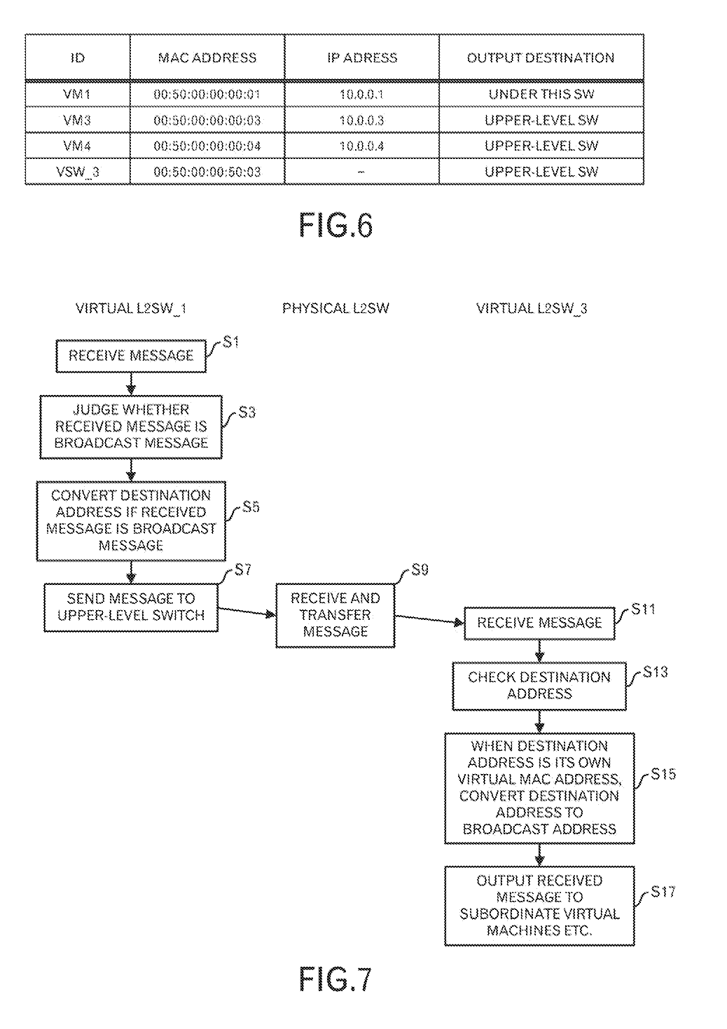

In addition, a transfer table storage area 109 is an area that is used by the transfer table manager 106, and stores data as illustrated in FIG. 6 for example. In the example in FIG. 6, identifiers, MAC addresses, IP addresses and output destination type (for example, under this switch, upper-level switch or the like) of the virtual L2SWs and virtual machines that belong to the same subnet are registered. Thus, it is possible to identify the output destination according to the MAC address.

The private switch data, conversion table and transfer table are registered for each of the virtual L2SW_2 and virtual L2SW_3 as well.

Next, a processing explained using FIG. 2 is explained in detail using FIG. 7. First, when the communication IF 101 of the virtual L2SW_1 receives a message from the virtual machine VM1 (step S1), the communication IF 101 outputs the message to the message controller 102. The message controller 102 judges, whether the received message is a broadcast message, according to data of the message type table that is stored in the message type table storage area 103 (step S3). When the destination address is the broadcast address, the message controller 102 judges that the message is the broadcast message, and the message controller 102 outputs the received message to the message converter 105. The message converter 105 converts the destination address of the received message to the virtual MAC address of another virtual L2SW that belongs to the same subnet and that is stored in the conversion table storage area 108 (step S5). When plural virtual MAC addresses are registered in the conversion table, the message converter 105 copies the received massage (the number of registered virtual MAC addresses−1) times and converts the destination address to each of the virtual MAC addresses. The message converter 105 outputs the processed message to the message controller 102.

The message controller 102 outputs the destination address of the processed message to the transfer table manager 106 and requests data concerning the corresponding output destination. The transfer table manager 106 searches the transfer table that is stored in the transfer table storage area 109 using the destination address, and identifies the output destination. In the example in FIG. 2, data is received that represents the destination to be the upper-level SW (in other words, the physical L2SW). Therefore, the message controller 102 instructs the communication IF 101 to output the message whose destination address has been converted to the virtual MAC address of the virtual L2SW that belongs to the same subnet, according to output destination data from the transfer table manager 106. In the example in FIG. 2, the communication IF 101 outputs the message, whose address has been converted, to the physical L2SW of the upper-level SW (step S7).

When the physical L2SW receives the message from the virtual L2SW_1 of the physical server A, the physical L2SW identifies a port from which the message is to be outputted according to the destination address (i.e. the virtual MAC address of the virtual L2SW_3), and outputs the message to the identified port (step S9). In the example in FIG. 2, the message is outputted to the port that is connected to the physical server B on which virtual L2SW_3 is operating.

When the physical server B receives the message, the physical server B outputs the message to the virtual L2SW_3 according to the virtual MAC address of the virtual L2SW_3, which is the destination address of the received message. When the communication IF 101 of the virtual L2SW_3 receives the message (step S11), the communication IF 101 outputs the received message to the message controller 102. The message controller 102 checks the destination address of the received message (step S13). When doing this, the message controller 102 requests the private switch data manager 104 to output its own virtual MAC address that is included in its own switch data to compare its own virtual MAC address with the destination address of the received message.

When the destination address is the L2SW_3's own virtual MAC address, the message controller 102 converts the destination address of the received message to the broadcast address, which is a reserved address (step S15). Then, the message controller 102 instructs the communication IF 101 to output the message whose destination address was converted, to the subordinate virtual machines VM3 and VM4, and the communication IF 101 outputs the messages according to that instruction (step S17).

By carrying out such a processing as described above, because the broadcast message is not transmitted to the virtual L2SW_2 that belongs to other subnets without using the VLAN, the logical separation of subnets is adequately realized.

### Embodiment 2

In this embodiment, the logical separation of subnets using both the address conversion described in the first embodiment and a VLAN is considered. This is because, when the VLAN can be used, utilization of the VLAN is efficient. However, because there are only 4,094 VLAN IDs, when the number of subnets exceeds this number, not all of the subnets can use the VLAN. Therefore, for example, the VLAN is used for predetermined subnets, and address conversion as described in the first embodiment is carried out for other subnets.

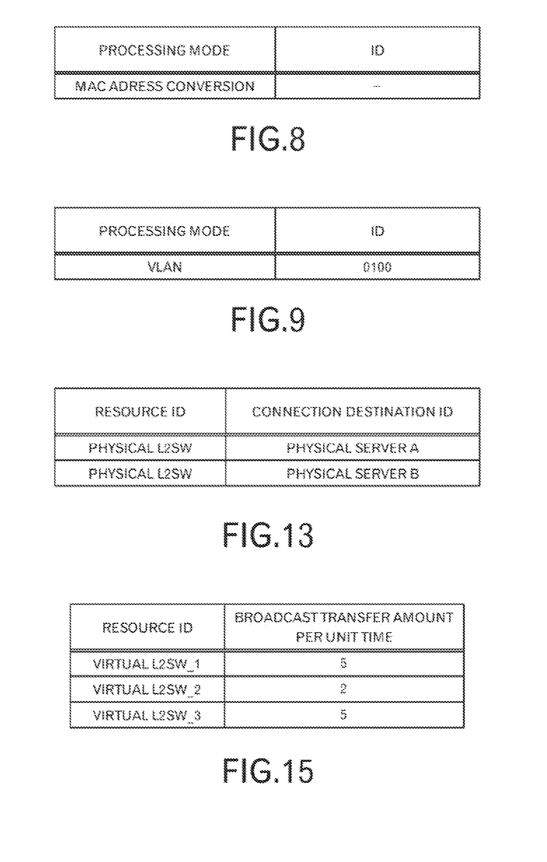

The virtual L2SW of this embodiment has the same configuration as the configuration illustrated in FIG. 3. However, data such as is illustrated in FIG. 8 or FIG. 9 is additionally held in the conversion table storage area 108. FIG. 8 is data that is held when carrying out the address conversion as in the first embodiment, and includes data representing a “MAC address conversion” mode as the processing mode. On the other hand, as illustrated in FIG. 9, when the VLAN is used, the data includes data representing a “VLAN” mode as the processing mode and a VLAN identifier (also notated as VLAN-ID).

Incidentally, in the case of a normal physical L2 switch, it is necessary to register the VLAN-ID for each port. As for the virtual L2SW of this embodiment, it is assumed that the virtual machines belonging to a different subnet are not connected, and in the VLAN mode of the virtual L2SW, the output destination is not specially selected by identifying the VLAN-ID. However, because, in the physical L2SW, VLAN-IDs are distinguished, there is not a particular problem. Incidentally, when the VLAN-IDs are distinguished to select the output destination in the virtual L2SW as well, the association with the VLAN-ID is registered into the transfer table.

In the case where the virtual L2SW_1 and virtual L2SW_2 and the virtual machines 1, 3 and 4 belong to the same subnet, when mode setting data such as illustrated in FIG. 8 is registered in the conversion table storage area 108 of the virtual L2SW_1 and virtual L2SW_3, the same processing as illustrated in FIG. 2 is carried out. However, at the step S5 in FIG. 7, an additional processing of checking whether or not the mode is the MAC address conversion mode is carried out. Incidentally, when the mode is the VLAN mode, the processing moves to the same processing as the processing carried out in a network that uses the normal VLAN without moving to the step S9.

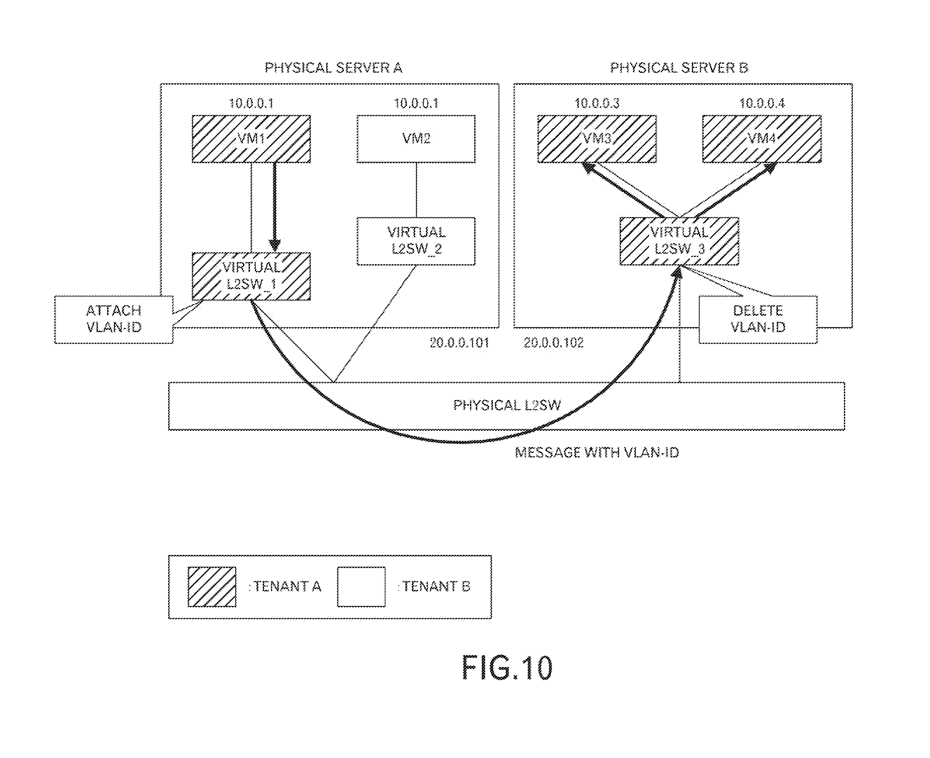

On the other hand, when the mode setting data such as illustrated in FIG. 9 is registered in the conversion table storage area 108 of the virtual L2SW_1 and virtual L2SW_3, a processing as illustrated in FIG. 10 is carried out.

In other words, it is assumed that a broadcast message is output from the virtual machine VM1 of the tenant A. A broadcast address, which is a reserved address, is set as the destination address in this broadcast message, and upon receiving this message, the virtual L2SW_1 checks whether the mode is the VLAN mode according to the mode setting data, and when the mode is the VLAN mode, the virtual L2SW_1 adds the VLAN-ID registered in association with the mode to the received message. Then, the virtual L2SW_1 outputs the message with the VLAN-ID to the physical L2SW, which is the upper-level L2 switch.

Incidentally, in the example in FIG. 10, only the virtual machine VM1 is connected to virtual L2SW_1, however, when more virtual machines are connected, a broadcast message is outputted to the virtual machines in the same way as a normal broadcast message.

As in the case where a normal broadcast message with a VLAN-ID is received, the physical L2SW identifies the corresponding output destination ports based on the VLAN-ID, and outputs the received broadcast message with the VLAN-ID to all of the identified output destination ports. In this case, the physical L2SW outputs the message to the virtual L2SW_3 of the physical server B. Incidentally, this broadcast message is not outputted to the virtual L2SW_2 that is not associated with the same VLAN-ID.

When the virtual L2SW_3 that is operating on the physical server B receives the broadcast message with the VLAN-ID that is the same as its own VLAN-ID, the virtual L2SW_3 deletes the VLAN-ID from that broadcast message. Then, the virtual L2SW_3 outputs that message as a broadcast message to the subordinate virtual machines VM3 and VM4.

In this way, when, in the VLAN mode, the same processing is carried out as in a normal network that uses VLAN.

Incidentally, in the VLAN mode, copying of additionally required messages is mainly carried out by the physical L2SW. Therefore, the load of the virtual L2SW is reduced.

### Embodiment 3

The second embodiment does not assume dynamic change of the mode setting, however, the number of subnets, the number of virtual machines, the number of virtual L2SWs and the number of times the broadcast messages are transmitted dynamically change. Consequently, the fixed mode setting cannot always be said to be efficient for the overall system.

Therefore, in this embodiment, a mechanism is employed in which a resource manager apparatus determines whether each of all subnets should operate in the VLAN mode, or should operate in the address conversion mode.

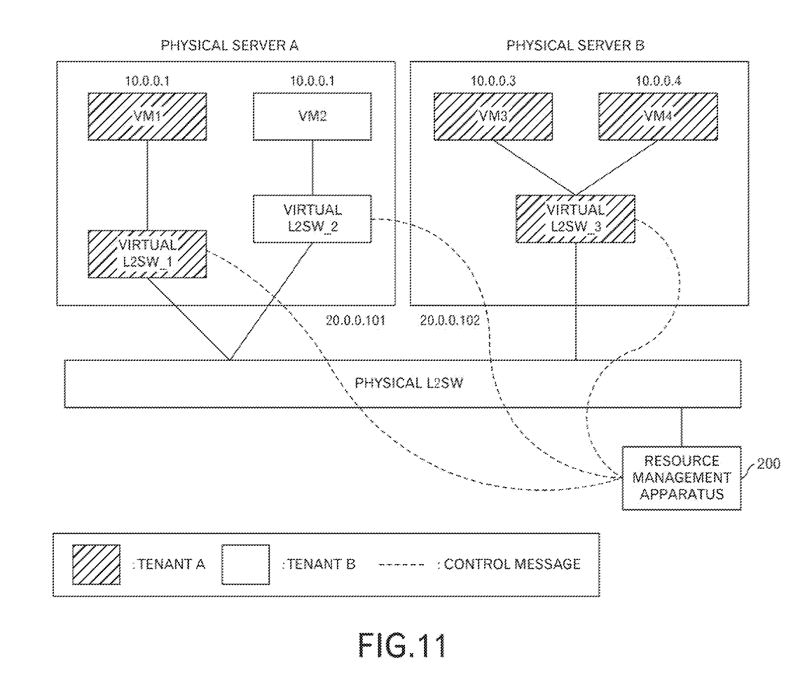

First, an outline of the system relating to this embodiment is illustrated in FIG. 11. As illustrated in FIG. 11, basically a resource management apparatus 200 is introduced into the system illustrated in FIG. 2 and FIG. 10, and is connected to the physical L2SW, for example. The resource management apparatus 200 transmits a control message to the virtual L2SWs that are operating in the system, as depicted by the dashed line, and instructs the virtual L2SWs to carry out setting of data, the mode switching or the like.

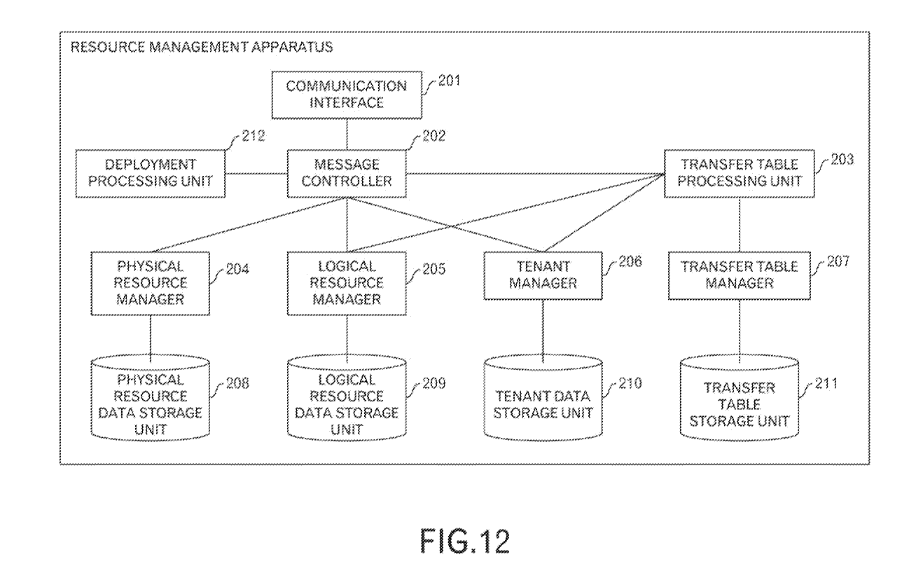

Next, the configuration of the resource management apparatus 200 is explained using FIG. 12. The resource management apparatus 200 has: a communication interface (IF) 201 that carries out communication with the physical L2SW and the like; a message controller 202 that carries out a control processing for messages that are transmitted and received and the like; a physical resource manager 204 that cooperates with the message controller 202 to carry out a processing for managing physical resources in the system; a physical resource data storage unit 208 that stores physical resource data; a logical resource manager 205 that cooperates with the message controller 202 to carry out a processing for managing logical resources in the system; and a logical resource data storage unit 209 that stores logical resource data.

Moreover, the resource management apparatus 200 has: a tenant manager 206 that cooperates with the message controller 202 to carry out a processing for managing data of tenants (i.e. customers) that use the system; a tenant data storage unit 210 that stores tenant data; a transfer table processing unit 203 that cooperates with the message controller 202 to carry out a processing for changing the transfer table for its own apparatus and the virtual L2SWs; a transfer table manager 207 that cooperates with the transfer table processing unit 203 to make changes to the transfer table for the overall system; and a transfer table storage unit 211 that stores the transfer table for the overall system.

Furthermore, the resource management apparatus 200 also has a deployment processing unit 212. This deployment processing unit 212 is a unit to realize functions that a virtual system normally has, such as cooperating with the message controller 202 to ensure logical resources from a resource pool and deploying the logical resources on the physical server according to a predetermined algorithm, and returning unnecessary logical resources to the resource pool.

Incidentally, the transfer table processing unit 203 also cooperates with the logical resource manager 205 and tenant manager 206.

An example of data that is stored in the physical resource data storage unit 208 is illustrated in FIG. 13. In the example in FIG. 13, the resource IDs of the physical resources such as the physical L2SW are registered in association with the connection destination IDs of the physical servers that are the connection destinations. In the example in FIG. 13, data enabling to grasp that the physical L2SW is connected with the physical servers A and B is stored as depicted in FIG. 11.

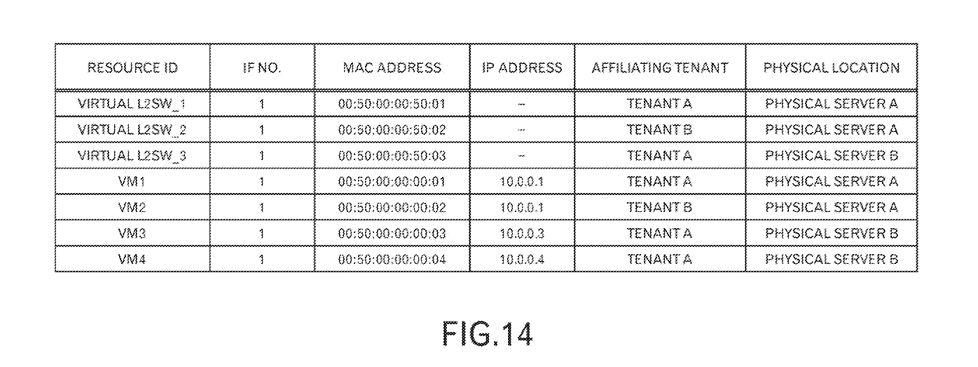

Next, an example of data that is stored in the logical resource data storage unit 209 is illustrated in FIG. 14. In the example in FIG. 14, the resource ID, IF number, which is the number of the interface that the resource of that resource ID uses, MAC address, IP address, tenant to which the logical resource belong, and physical location that represents on which physical server the logical resource is operating are registered in association with each other.

Furthermore, data such as illustrated in FIG. 15 is also stored in the logical resource data storage unit 209. In the example in FIG. 15, the resource ID of the virtual L2SW is stored in association with the broadcast transfer amount per unit time. Instead of the resource ID, the broadcast transfer amount per unit time may be stored for each subnet.

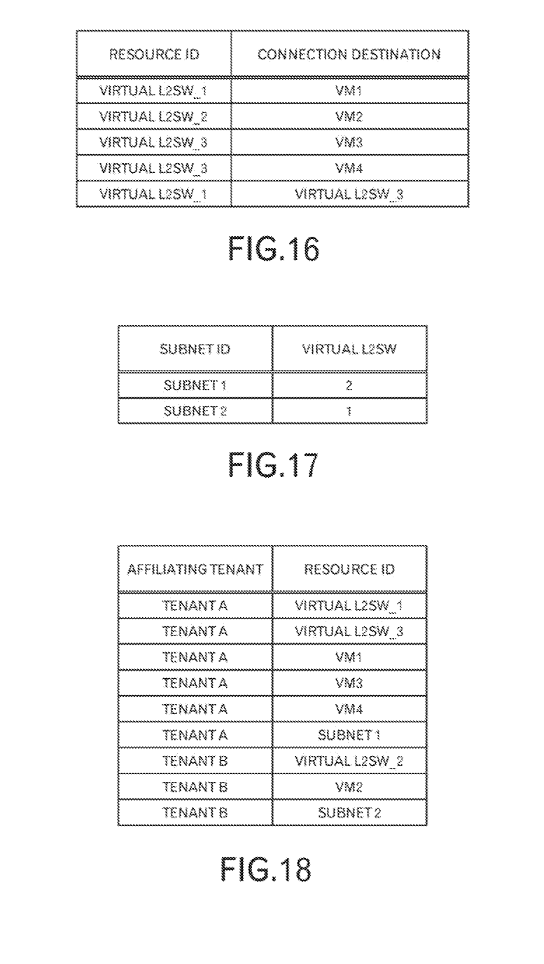

In addition, data such as illustrated in FIG. 16 is also stored in the logical resource data storage unit 209. In the example in FIG. 16, the resource ID of the virtual L2SW is registered in association with the ID of the logical resource that is the connection destination.

In this way, it is possible to grasp the logical system configuration from FIG. 14 and FIG. 16. Moreover, as will be explained below, by using FIG. 15, dynamic mode switching is possible.

Furthermore, data such as illustrated in FIG. 17 is also stored in the logical resource data storage unit 209. In the example in FIG. 17, the subnet ID is registered in associated with the number of virtual L2SWs that are included in the subnet. Thus, it becomes possible to calculate the load of the virtual L2SWs when a processing is carried out in the address conversion mode.

In addition, an example of data that is stored in the tenant data storage unit 210 is illustrated in FIG. 18. In the example in FIG. 18, the affiliating tenant name is registered in association with the resource ID of the logical resource or the subnet. Thus, it is possible to identify which tenant the logical resource and subnet belong to.

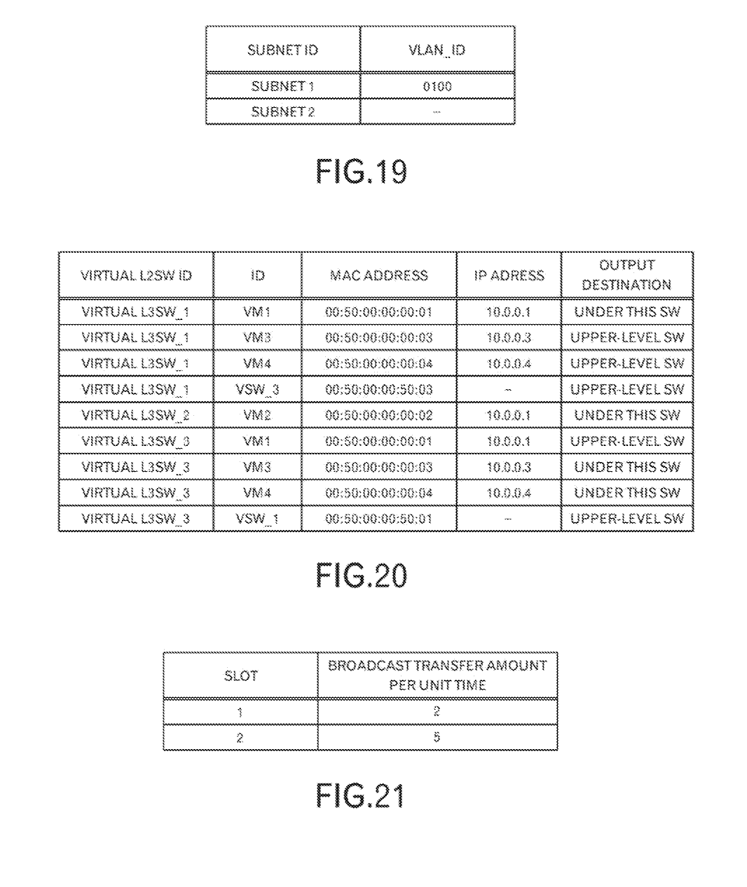

Furthermore, data such as illustrated in FIG. 19 is also stored in the tenant data storage unit 210. In the example in FIG. 19, the subnet ID is registered in association with the VLAN-ID when the VLAN-ID is assigned. Thus, the operation mode can be identified for each subnet. More specifically, the VLAN mode is set for the subnets for which the VLAN-ID is registered, and the address conversion mode is set for the subnets for which the VLAN-ID is not registered.

In addition, an example of the data that is stored in the transfer table storage unit 211 is illustrated in FIG. 20. In the example in FIG. 20, the ID of the relevant virtual L2SW, the ID of the logical resource that is the connection destination of the virtual L2SW, the MAC address of the logical resource, the IP address of the logical resource, and the output destination (under this switch or upper-level switch) are registered. In other words, the transfer table storage unit 211 holds all of the contents of the transfer tables held by each of the virtual L2SWs, which exist in the system.

In addition, the virtual L2SW relating to this embodiment has the same configuration as that of the second embodiment. However, as an additional function, the message converter 105 counts the number of broadcast messages for each unit time, and when the amount of change of the number of broadcast messages exceeds a predetermined threshold value, the message converter 105 sends a broadcast transfer amount change notification to the resource management apparatus 200. For example, the unit time is called a slot.

Furthermore, the conversion table storage area 108 also holds data such illustrated in FIG. 21. In the example in FIG. 21, the slot number, and the broadcast transfer amount (more specifically, the number of broadcast messages) per unit time (i.e. 1 slot) are registered. For example, a case in which the broadcast transfer amount is “2” in the first slot, and increases to “5” in the second slot is illustrated in FIG. 21. When the threshold value is “3”, for example, the broadcast transfer amount change notification is sent.

Furthermore, the message controller 102 identifies a control message from the resource management apparatus 200 with the message type table storage area 103 and carries out a processing required according to the control message. For example, when a control message instructing to set or update the transfer table is received, the message controller 102 instructs the transfer table manager 106 to set or update the transfer table.

Similarly, when a control message instructing to set its own switch data is received, the message controller 102 instructs the private switch data manager 104 to set its own switch data. Furthermore, when a control message instructing to set or update the conversion table is received, the message controller 102 instructs the message converter 105 to set or update the conversion table.

Next, presetting of this system will be explained. In a virtualized system such as a cloud system, the presetting is divided into two phases: physical system construction and virtual system construction.

[Physical System Construction]

The physical system construction is carried out using a method similar to the conventional system construction. In this phase, various settings are performed such as arrangement of the physical devices such as the physical servers, physical wire connection, setting of the IP addresses of the physical servers, and setting of the physical switches (for example, L2 and L3) when necessary. Incidentally, in FIG. 11, the physical switch L3 is not included, however, generally, the physical construction is not limited to the physical construction as illustrated in FIG. 11, and a system that uses a physical L3 switch may be employed.

[Logical System Construction]

A logical system is a system that customers (in other words, tenants) use, and is constructed by the following procedure when triggered by some kind of action (for example, application for use) from a customer.

(1) The resource management apparatus 200 receives a customer action. Here, the system for “tenant A” in FIG. 11, or more specifically, a system is constructed in which three virtual machines are arranged in the same subnet.

(2) The deployment processing unit 212 of the resource management apparatus 200 acquires resources for the three virtual machines from a resource pool. In the following, setting is made for each server.

(a) Designation of the number of Network Interface Cards (NICs) is received from a customer, and a MAC address is assigned for each NIC. The MAC addresses are assigned so that there is no duplication of addresses in the system.

(b) Designation of the IP address, network address and subnet mask is received for each NIC from the customer. Setting of the designated contents into the virtual machine is made via a DHCP (Dynamic Host Configuration Protocol) server when the virtual server is activated. The function of the DHCP server is well known, so the further explanation is omitted here.

(c) The deployment processing unit 212 of the resource management apparatus 200 determines the deployment destination physical server of the virtual machine according to a predetermined algorithm. For example, an algorithm is employed that a server is randomly selected, or that a server having little room for resources is assigned in order to concentrate the virtual machines to some servers as long as possible. The processing for determining a deployment destination is well-known technique, so further explanation is omitted here.

(3) The resource management apparatus 200 determines the necessary virtual L2SW according to the logical resource status of the deployment destination of the virtual machines. Here, one virtual machine is deployed to the physical server A, and two virtual machines are deployed to the physical server B, and the deployment processing unit 212 deploys the virtual L2SW to each of the physical servers. When doing this, a virtual MAC address is assigned to each virtual L2SW. The processing required for this embodiment is described below.

(4) The mode to be set for each subnet is determined according to the deployment of the virtual L2SWs and the like, and the mode setting is also made for the virtual L2SWs that belong to each subnet. The processing required at this time in this embodiment will be described below.

(5) Based on the assigned MAC addresses and IP addresses designated by the customer, the transfer table processing unit 203 generates a transfer table (FIG. 19) and causes the transfer table manager 207 to stores the generated table into the transfer table storage unit 211. Moreover, the transfer table processing unit 203 causes the message controller 202 to transmit the relevant portion of the transfer table to each of the virtual L2SW as a control message. After receiving a control message, the message controller 102 of the virtual L2SW recognizes that the message is the control message from data that is stored in the message type table storage area 103, and instructs the transfer table manager 106 to set or update the transfer table according to the control message.

Furthermore, the logical resource manager 205 stores the logical resource data (FIG. 14, FIG. 16 and FIG. 17) into the logical resource data storage unit 209 based on the settings described above. Incidentally, a preset initial value is set for the broadcast transfer amount per unit time as illustrated in FIG. 15. In addition, the logical resource manager 205 causes the message controller 202 to transmit, to each virtual L2SW, a control message for registering a conversion table (i.e. virtual MAC addresses of other virtual L2SWs on the same subnet) and its own switch data (i.e. virtual MAC address of its own virtual L2SW).

Moreover, the tenant manager 206 stores tenant data into the tenant data storage unit 210 based on the settings described above. Furthermore, the tenant manager 206 stores mode setting data such as illustrated in FIG. 19 into the tenant data storage unit 210 according to results of the mode setting that will be described in detail later. In addition, the tenant manager 206 causes the message controller 202 to transmit a control message instructing each virtual L2SW to carry out the mode setting.

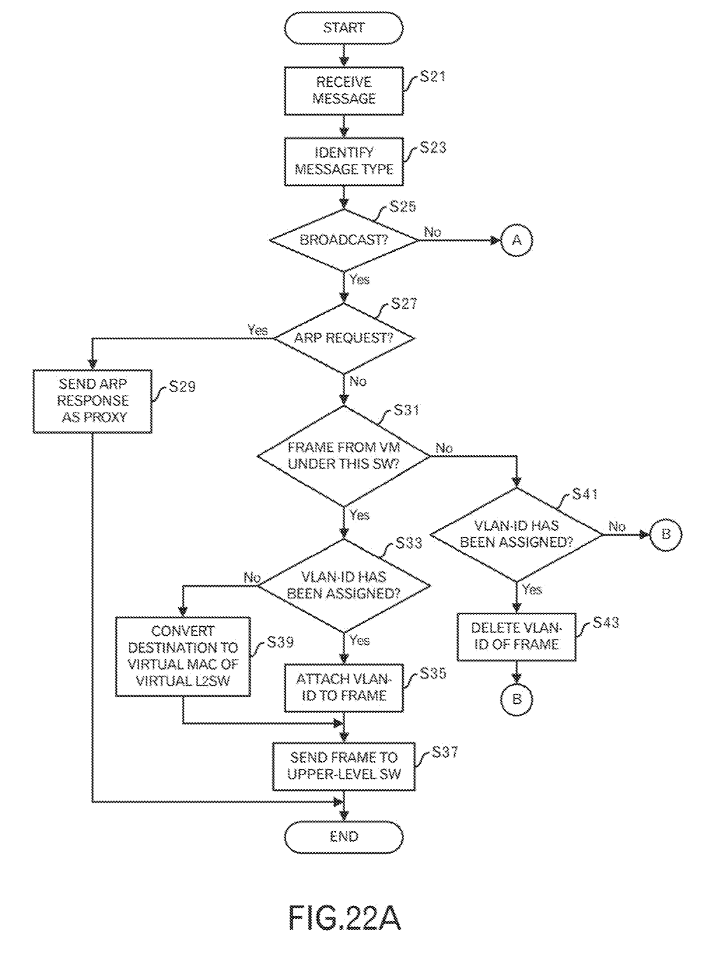

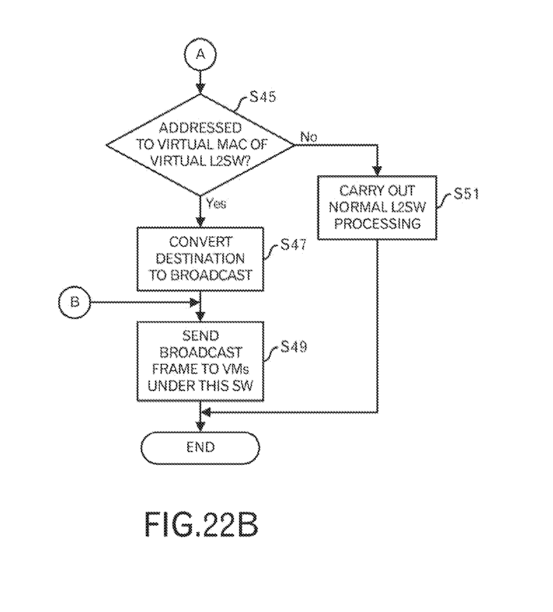

After setting has been carried out in this way, the system operates as the system illustrated in FIG. 11. Then, each virtual L2SW carries out a processing such as illustrated in FIG. 22A to FIG. 25.

When the communication IF 101 of the virtual L2SW receives a message (i.e. a MAC frame) (step S21), the communication IF 101 outputs that message to the message controller 102. The message controller 102 identifies the message type based on data that is stored in the message type table storage area 103 (step S23). In this embodiment, the message controller 102 identifies whether the message is a broadcast message (also called a broadcast frame), or an Address Resolution Protocol (ARP) request among the broadcast messages.

When the message controller 102 determines that the message is the broadcast message (step S25: YES route), the message controller 102 determines whether or not an ARP request was received (step S27). When the ARP request has been received (step S27: YES route), the message controller 102 causes the transfer table manager 106 to search the transfer table using the IP address included in the ARP request, to read the corresponding MAC address and to output that MAC address to the message controller 102. Then, the message controller 102 outputs a set of the MAC address and IP address to the message converter 105, and causes the message converter 105 to generate an ARP response. The message controller 102 replies with the ARP response obtained from the message converter 105 to the virtual machine of the requesting source via the communication IF 101 (step S29). The processing then ends.

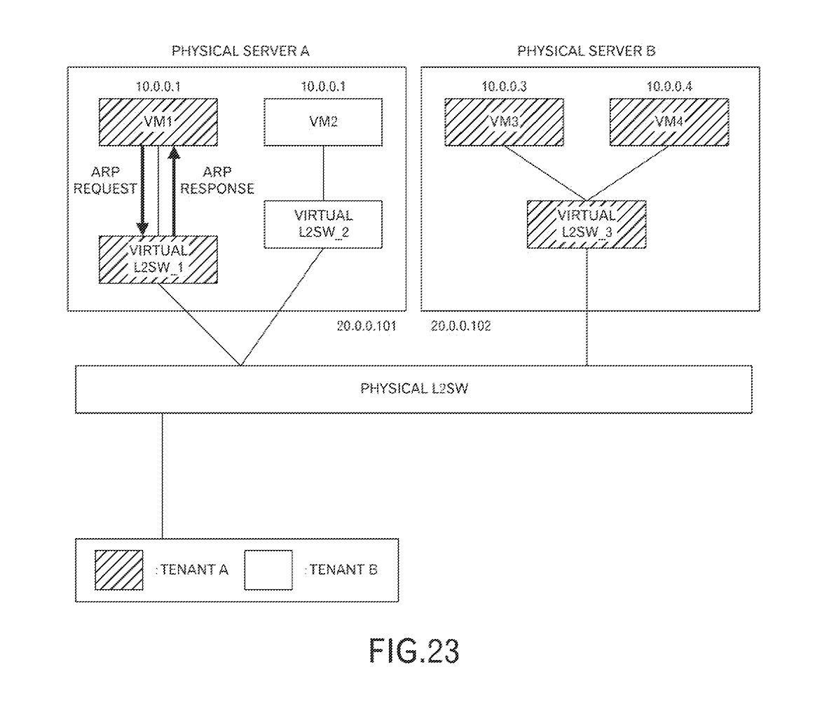

As schematically illustrated in FIG. 23, when the virtual L2SW_1 receives the ARP request from the virtual machine VM1, for example, the virtual L2SW_1 acquires the relevant MAC address from the transfer table without transmitting the ARP request to the virtual machines on the same subnet, and as a proxy, replies with the ARP response to the virtual machine VM1. In this way, the ARP request is not leaked to other subnets. Moreover, it is possible to reduce the load on the virtual machines of the same subnet and the like.

On the other hand, when the message is not the ARP request (step S27: NO route), the message controller 102 outputs the MAC address of the transmission source to the transfer table manager 106 and causes the transfer table manager 106 to check whether or not the message is a message from a virtual machine VM that is subordinate to its own switch (step S31). When it is known from the response from the transfer table manager 106 that the received message is a message from the virtual machine VM1 subordinate to its own switch, the message controller 102 causes the message converter 105 to check whether or not a VLAN-ID is assigned, or in other words, whether or not the VLAN mode is set (step S33). It is possible to judge whether or not the VLAN mode is set, based on the mode setting data held in the conversion table storage area 108. When the VLAN mode is set, the message controller 102 outputs the received message to the message converter 105. The message converter 105 attaches the VLAN-ID of the subnet to which its own virtual L2SW belongs to the received message (in other words, MAC frame) (step S35), and outputs the message with the VLAN-ID to the message controller 102. Then, the message controller 102 causes the communication IF 101 to output the message with the VLAN-ID to the upper-level switch (step S37). As schematically illustrated in FIG. 11, the operation is the same as in the normal VLAN. The processing then ends.

On the other hand, when there is no assignment of the VLAN-ID and the address conversion mode is set, the message controller 102 outputs the received message to the message converter 105, and the message converter 105 replaces the destination address of the received message with a virtual MAC address of another virtual L2SW included in the conversion table and belonging to the same subnet (step S39), and the message converter 105 outputs the received message in which the destination address is replaced to the message controller 102. Moreover, the processing moves to step S37. In this way, as illustrated in FIG. 2, it is possible to avoid having the broadcast message output to other subnets even though the VLAN is not used.

Furthermore, when the message is not from a virtual machine that is subordinate to its own switch (step S31: NO route), or in other words, when the message is from a upper-level switch, the message controller 102 determines whether or the VLAN-ID is attached to the received message as a VLAN tag (step S41). When the VLAN-ID is attached to the received message, the message controller 102 outputs the received message to the message converter 105, and the message converter 105 deletes the VLAN-ID from the received message (step S43), and outputs the message to the message controller 102. The message controller 102 causes the communication IF 101 to output a broadcast message to the virtual machines that are subordinate to the L2SW's own switch (step S49). In this way, even when the broadcast message with the VLAN-ID as the VLAN tag is received, the operation is made similarly to the operation for the normal VLAN.

On the other hand, when, for some reasons, a broadcast message is received that does not include any VLAN-ID, the message controller 102 causes the communication IF 101 to output the received message as it is to the virtual machines that are subordinate to the L2SW's own switch (step S49).

On the other hand, when it is determined according to the message type table that the received message is a normal message (step S25: NO route), the message controller 102 requests the private switch data manager 104 to output the virtual MAC address of the L2SW's own switch, and determines whether the destination address of the received message is the same as the virtual MAC address of the L2SW's own switch (step S45). When the destination address of the received message is the same as the virtual MAC address of the L2SW's own switch, the message controller 102 outputs the received message to the message converter 105, and the message converter 105 replaces the destination address with a predetermined broadcast address (step S47), and then replies with the processed message to the message controller 102. In addition, shifting to the step S49, the message controller 102 outputs the received message after the destination address is replaced to the virtual machines subordinated to the L2SW's own switch. By doing so, as illustrated in FIG. 2, it is possible to distribute a broadcast message to virtual machines within a suitable range even without using the VLAN.

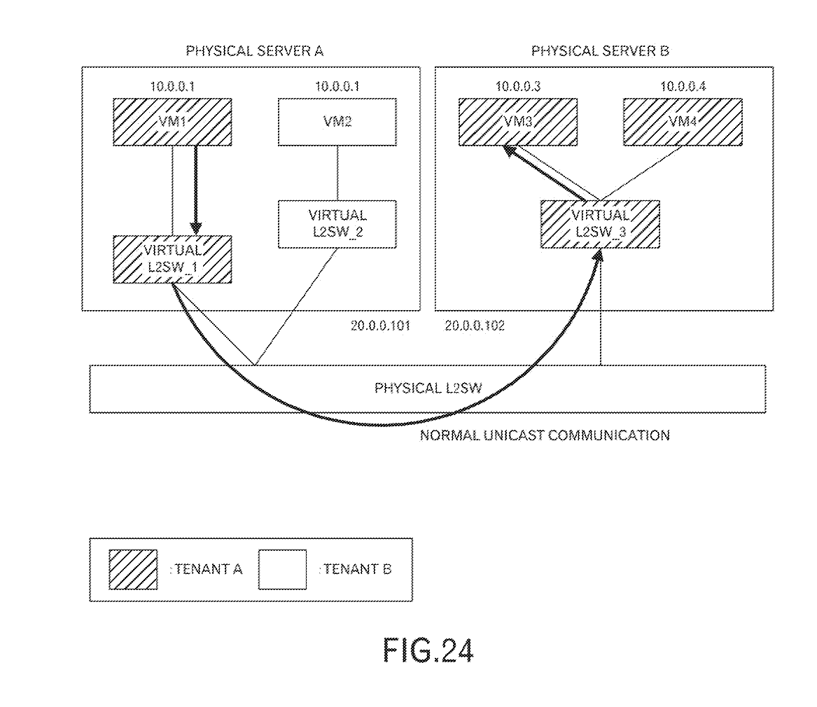

On the other hand, when the destination address of the received message is not the virtual MAC address of its own virtual L2SW (step S45: NO route), the message is a normal unicast message. Therefore, the message controller 102 causes the transfer table manager 106 to identify the output destination from the MAC address of the received message, and outputs the received message according to the identified output destination (step S51). In other words, the virtual L2SW processes the received message as the normal L2SW. For example, as illustrated in FIG. 24, when the virtual machine VM1 on the physical server A transmits a message to the virtual machine VM3 of the physical server B, the virtual L2SW_1 extracts, from the transfer table, the output destination that corresponds to the destination address, and outputs the received message to the upper-level switch (here, the physical L2SW). The physical L2SW similarly selects the output destination port from the destination MAC address, and outputs the received message to the virtual L2SW_3 of the physical server B. The virtual L2SW_3 searches the transfer table with the destination address of the received message, and outputs the received message to the virtual machine VM3 that is subordinate to its own switch. By doing so, the normal unicast communication is carried out. Incidentally, when the virtual L2SW_1 determines that the output destination is a virtual machine subordinate to its own virtual L2SW_1, the processing is simple, and the virtual L2SW_1 outputs the received message itself as it is to the virtual machine having the destination MAC address without outputting the message to another L2SW.

By carrying out a processing as described above by the virtual L2SW, it is possible to handle messages considered in this embodiment. Incidentally, as described above, the control message makes the corresponding storage area updated with data designated by the control message. Data representing the mode to be set is also included in the control message, and the conversion table storage area 108 is updated by this data.

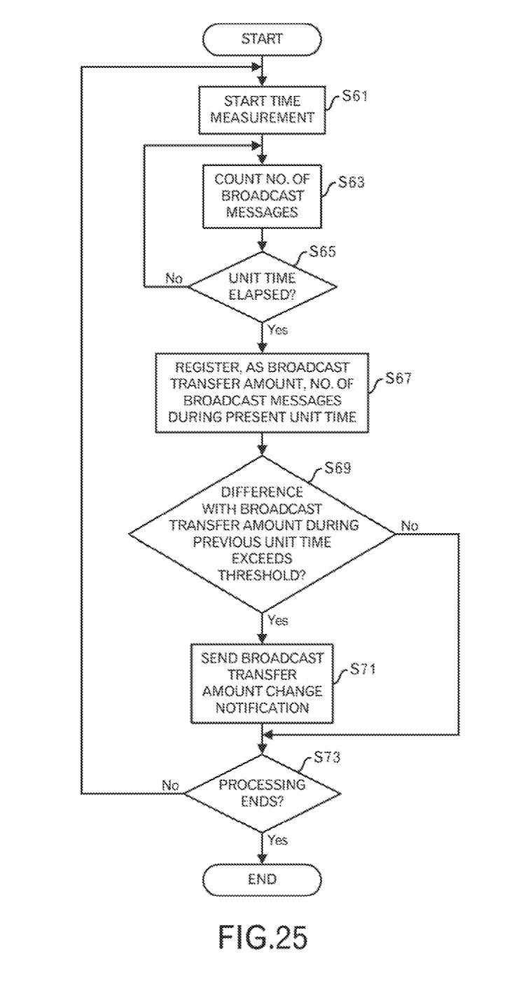

Incidentally, for example, the message converter 105 of the virtual L2SW carries out a processing such as illustrated in FIG. 25 in the background, and notifies the resource management apparatus 200 of a trigger for changing the mode being set.

First, for example, the message converter 105 starts time measurement (step S61). Then, when the message controller 102 outputs a broadcast message (including a message in which its own virtual MAC address is set as the destination address) to the message converter 105, the message converter 105 counts the number of broadcast messages (step S63). This processing is repeated until a preset unit time has elapsed (step S65).

After the unit time has elapsed, the message converter 105 stores the number of broadcast messages during the present unit time as the broadcast transfer amount into the conversion table storage area 108 (for example, the data structure in FIG. 21) (step S67). After that, the message converter 105 determines whether the difference between the current broadcast transfer amount at this time and the broadcast transfer amount of the previous unit time is equal to or greater than a threshold value (step S69). When the different is less than the threshold value, the message converter 105 moves to step S73. However when the difference is equal to or greater than the threshold value, the message controller 105 generates a broadcast transfer amount change notification that includes the current broadcast transfer amount, and outputs generated notification to the message controller 102, after which the message controller 102 causes the communication IF 101 to transmit the broadcast transfer amount change notification to the resource management apparatus 200 (step S71).

Such a processing is repeated until the processing ends such as when the operation of the virtual L2SW is stopped (step S73). In other words, when the processing has not ended, the processing returns from the step S73 to the step S61.

In this processing flow, the flow is illustrated as returning to the step S61 after the step S71, however, actually, separately from the step S67 to the step S71, the processing returns to the step S61 and the number of broadcast messages is counted during the next unit time.

Thus, it is possible to notify the resource management apparatus 200 of a trigger for changing the mode being set.

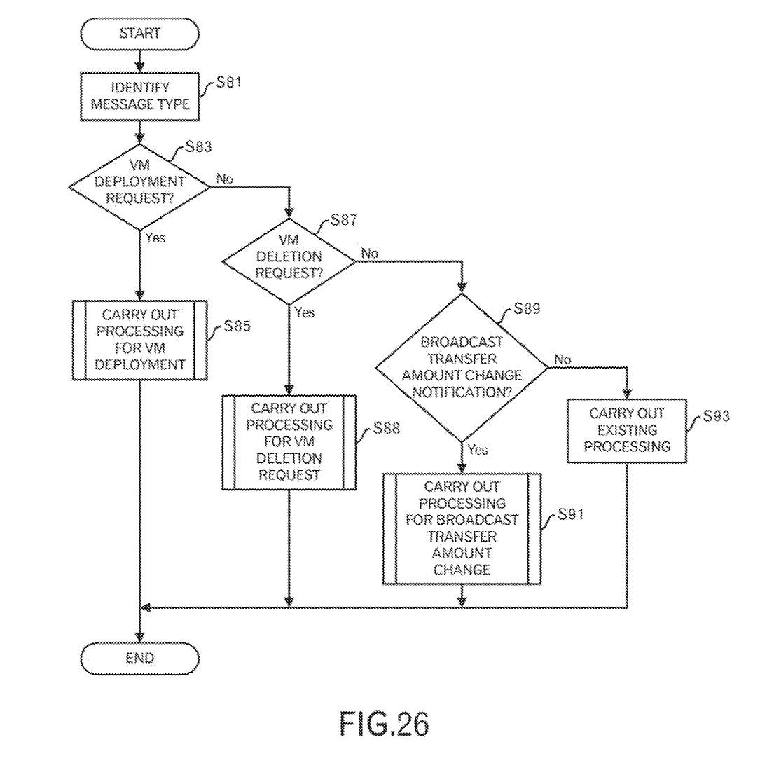

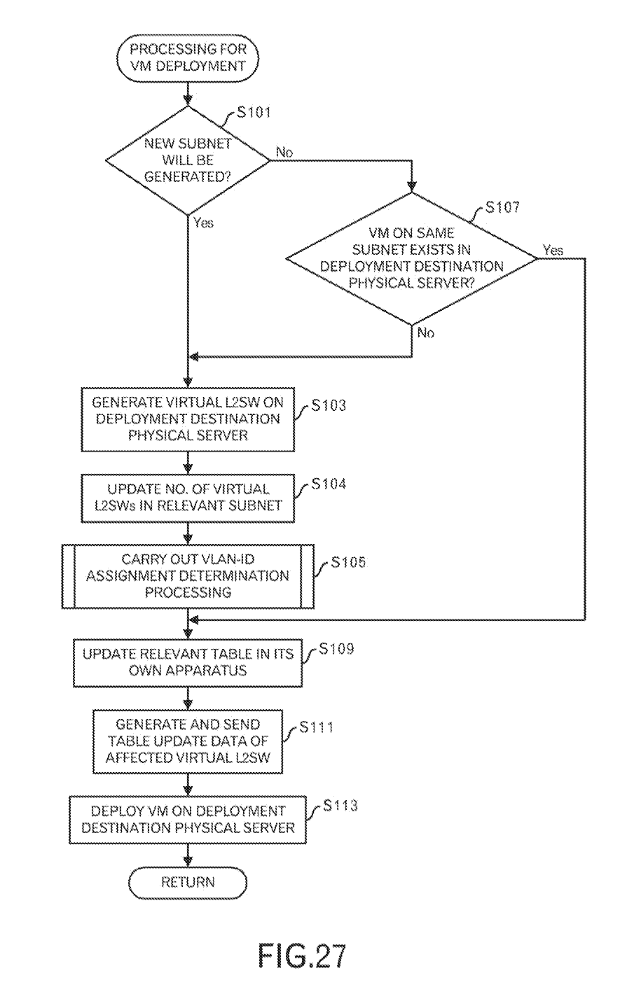

Next, the processing by the resource management apparatus 200 will be explained using FIG. 26 to FIG. 30. The message controller 202 of the resource management apparatus 200 identifies the message type of a message received by the communication IF 201 (step S81). The message controller 202 determines whether or not the received message is a VM deployment request outputted by the deployment processing unit 212, for example, which executes a processing in response to a request from a customer terminal or other program (step S83). When the message is the VM deployment request, the message controller 202 carries out a processing for the VM deployment (step S85). This processing for the VM deployment will be explained using FIG. 27.

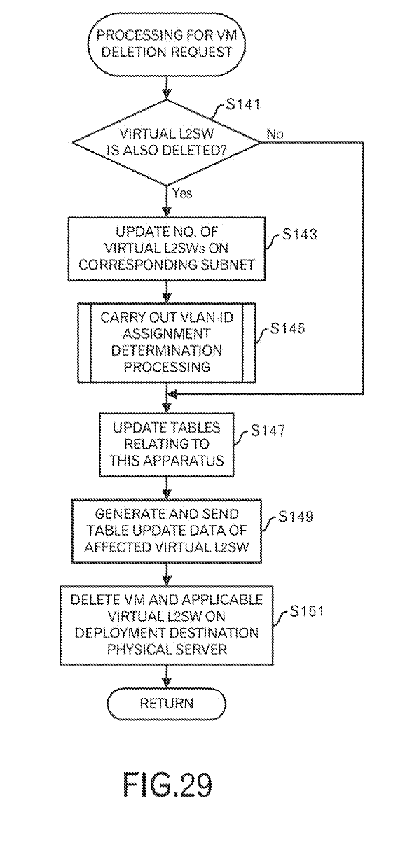

On the other hand, when the message is not the VM. deployment request, the message controller 202 determines whether or not the received message is a VM deletion request from a customer terminal or other program (may be from the deployment processing unit 212) (step S87). When the message is the VM deletion request, the message controller 202 carries out a processing for the VM deletion request (step S88). This processing for the VM deletion request will be explained using FIG. 29.

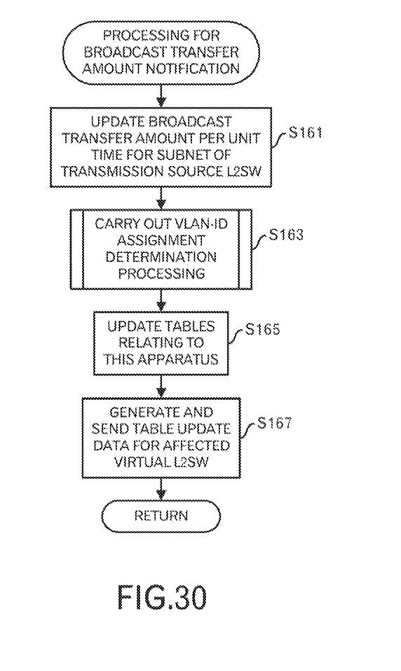

Furthermore, when the message is not the VM deletion request, the message controller 202 determines whether or not the message is a broadcast transfer amount change notification (step S89). When the message is the broadcast transfer amount change notification, the message controller 202 carries out a processing for the broadcast transfer amount change (step S91). This processing for the broadcast transfer amount change will be explained using FIG. 30.

On the other hand, when the message is not the broadcast transfer amount change notification, the message controller 202 carries out the existing processing (step S93), and the processing ends.

In this way, the message controller 202 checks, for each specific message, whether or not the condition for changing the mode is satisfied, and, when necessary, the message controller 202 changes the mode.

Next, the processing for the VM deployment is explained using FIG. 27. The message controller 202 causes the logical resource manager 205 to inquire whether a new subnet will be generated that includes a virtual machine to be deployed in response to the present VM deployment request (step S101). For example, the VM deployment request includes data such as the affiliating tenant identifier (ID), subnet identifier (ID), deployment destination physical server name, IP address, MAC address and the like. Then, when the VM deployment request requests the deployment of a virtual machine used by a tenant that is not included in the data stored in the logical resource data storage unit 209 (FIG. 14 to FIG. 17), a new subnet is generated. A tenant may use plural subnets. However, in such a case, the message controller 202 inquires of the tenant manager 206. In the following, a case where a check is required is the same.

When a new subnet does not need to be generated (step S101: NO route), the message controller 202 inquires of the logical resource manager 205 whether or not there is another virtual machine on the same subnet in the deployment destination physical server of the virtual machine that will be deployed according to this VM deployment request (step S107). For example, the message controller 202 determines whether or not a virtual machine belonging to a tenant having the same tenant name that is included in the VM deployment request has been deployed in the deployment destination physical server that is also included in the VM deployment request.

When it is determined at the step S101 that a new subnet will be generated, or when it is determined at the step S107 that there is no virtual machine on the same subnet in the deployment destination physical server, the message controller 202 requests the deployment processing unit 212 to deploy a virtual L2SW to the deployment destination physical server of the virtual machine being deployed, and the deployment processing unit 212 deploys the virtual L2SW to the deployment destination physical server using a known method (step S103). Then, the message controller 202 causes the logical resource manger 205 to update the number of virtual L2SWs on the subnet relating to the VM deployment request in the logical resource data storage unit 209 (step S104). For example, in the table in FIG. 17, when the subnet ID is already registered, the number of virtual L2SWs is increased, and when the subnet ID is not registered, the relevant subnet ID and the number of virtual L2SWs to be added at this time are registered.

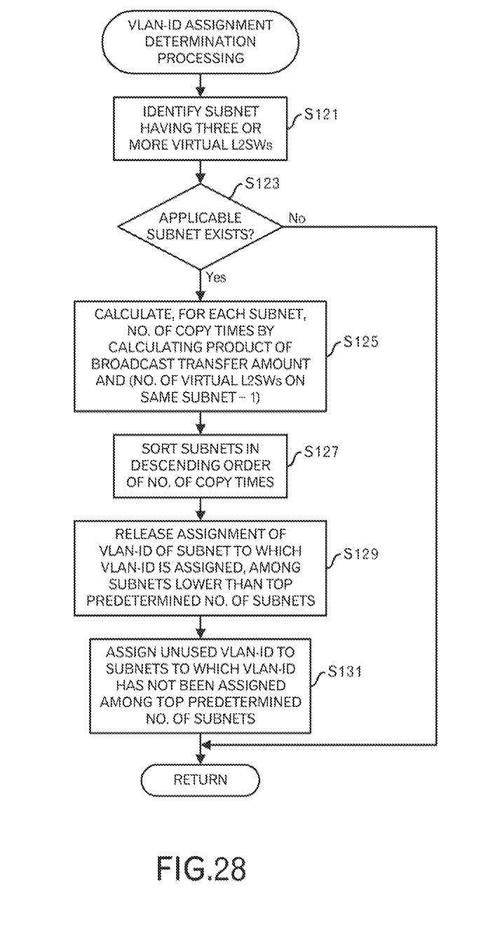

Furthermore, the message controller 202 causes the logical resource manager 205 to carry out a VLAN-ID assignment determination processing (step S105). This VLAN-ID assignment determination process is explained using FIG. 28.

First, based on data stored in the logical resource data storage unit 209 (for example, FIG. 17), the logical resource manager 205 identifies a subnet having three or more virtual L2SWs (step S121). In this embodiment, when the number of virtual L2SWs is “1” or “2”, the address conversion mode is set. Therefore, the step S121 is carried out. However, a subnet having two or more L2SWs may be identified.

Then, the logical resource manager 205 determines whether or not there is an applicable subnet (step S123). When there is no applicable subnet, the VLAN-ID is not assigned to any subnet, and the address conversion mode is set to all of the subnets. However, in this processing flow, the processing returns to the calling source processing without carrying out any special processing.

On the other hand, when there is an applicable subnet, the logical resource manager 205 reads out the number of virtual L2SWs (FIG. 17) for each subnet and the broadcast transfer amount per unit time (FIG. 15) that are stored in the logical resource data storage unit 209, calculates, for each subnet, the number of copy times the message is to be copied, by calculating the product of the broadcast transfer amount and (the number of virtual L2SWs included in the subnet−1), and stores the result into a memory device such as a main memory (step S125).

Then, the logical resource manager 205 sorts the subnets in descending order of the number of copy times (step S127). Then, the logical resource manager 205 releases the VLAN-ID assignment of the subnet, to which VLAN-ID is already assigned, among the subnets lower than a top predetermined ranking (more specifically, 4094) (step S129). In the case of firstly assigning the VLAN-ID, this step is skipped.

Furthermore, the logical resource manager 205 assigns unused VLAN-IDs to subnets that have not been assigned any VLAN-ID among a top predetermined number of subnets, and outputs the assignment result to the message controller 202 (step S131). Then, the processing returns to the calling source processing.

By performing such a processing, it is possible to assign VLAN-IDs to subnets in which many virtual L2SWs are included, and to subnets that the broadcast is frequently carried out, to reduce the load of the copying process that is carried out in the address conversion mode.

Returning to the explanation of the processing flow in FIG. 27, the message controller 202 causes the logical resource manager 205, tenant manager 206 and transfer table processing unit 203 to update relevant tables in the resource apparatus 200 (step S109). The logical resource manager 205 updates data as illustrated in FIG. 14, FIG. 16 and FIG. 17 according to the deployed virtual machines and virtual L2SWs. Moreover, the tenant manager 206 updates data as illustrated in FIG. 18 and FIG. 19 according to the deployed virtual machines and virtual L2SWs, and when the step S105 is carried out, the tenant manager 206 updates data according to the assignment status of the VLAN-IDs, which was received from the message controller 202. Furthermore, the transfer table processing unit 203 generates data for updating a transfer table as illustrated in FIG. 20 according to the deployed virtual machines and virtual L2SWs, and outputs the data to the transfer table manager 207. The transfer table manager 207 updates the data stored in the transfer table storage unit 211 according to the received data.

Moreover, the transfer table processing unit 203 outputs data of the affected portion of the transfer table that was updated according to the deployed virtual machines and virtual L2SWs to the message controller 202, for each virtual L2SW. The message controller 202 generates, for each affected virtual L2SW, a control message that includes, as the table update data, the data for the affected portion that was received from the transfer table processing unit 203, and in the case of the VLAN mode, the VLAN-IDs received from the logical resource manager 205, or in the case of the address conversion mode, data representing the address conversion mode, and causes the communication IF 201 to transmit the control message (step S111). By doing so, each affected virtual L2SW updates the conversion table storage area 108 and transfer table storage area 109.

Then, the message controller 202 causes the deployment processing unit 212 to deploy a virtual machine to the deployment destination physical server by a known method (step S113). The processing then returns to the calling source processing.

Incidentally, when it is determined at the step S107 that there is the virtual machine on the same subnet in the deployment destination physical server, the virtual L2SW does not need to be additionally deployed. Therefore, the processing moves to step S109.

As described above, there are cases where the status on the subnet changes due to the deployment of the virtual machine. Therefore, according to such change, it is properly judged, for each subnet, which is preferable among the VLAN mode and address conversion mode.

Next, the processing for the VM deletion request is explained using FIG. 29. First, the message controller 202 causes the logical resource manager 205 to inquire of the logical resource manager 205 whether there is a virtual L2SW that will completely lose its connection when a virtual machine designated by the VM deletion request is deleted (step S141). For example, in the data in FIG. 16, the logical resource manager 205 checks whether there is a virtual L2SW for which there is absolutely no virtual machine as the connection destination. Such a virtual L2SW is deleted.

When there is a virtual L2SW, which will be connected with absolutely no virtual machine as the connection destination, the message controller 202 causes the logical resource manager 205 to update the number of virtual L2SWs on the relevant subnet in the logical resource data storage unit 209 (step S143). The number of virtual L2SWs on the relevant subnet is reduced in the logical resource data storage unit 209 by just the number of virtual L2SWs to be deleted.

Then, the message controller 202 causes the logical resource manager 205 to carry out a VLAN-ID assignment determination processing (step S145). This processing is the same as the processing illustrated in FIG. 28.

After that, the message controller 202 causes the logical resource manager 205, tenant manager 206 and transfer table processing unit 203 to update the relevant tables in the resource management apparatus 200 (step S147). The logical resource manager 205 updates data such as illustrated in FIG. 14 and FIG. 16 according to the virtual machines and virtual L2SWs that are deleted. The tenant manager 206 updates data such as illustrated in FIG. 18 and FIG. 19 according to the virtual machines and virtual L2SWs that are deleted, and when the step S145 is carried out, the tenant manager 206 updates the data in FIG. 18 and FIG. 19 according to the VLAN-ID assignment state by the message controller 202. Moreover, the transfer table processing unit 203 generates data to update a transfer table as illustrated in FIG. 20 according to the virtual machines and virtual L2SWs that are deleted, and outputs the generated data to the transfer table manager 207. The transfer table manager 207 updates the data stored in the transfer table storage unit 211 according to the received data.

Furthermore, the transfer table processing unit 203 outputs, for each virtual L2SW, the data of the affected portion of the table updated according to the virtual machines and virtual L2SWs that are deleted, to the message controller 202. The message controller 202 generates, for each affected virtual L2SW, a control message, which includes as table update data, data of the affected portion received from the transfer table processing unit 203, and in the case of the LAN mode, VLAN-ID data received from the logical resource manager 205, and in the case of the address conversion mode, data representing the address conversion mode, and causes the communication IF 201 to transmit the control message (step S149). By doing so, each affected virtual L2SW updates the conversion table storage area 108 and transfer table storage area 109.

Then, the message controller 202 also causes the deployment processing unit 212 to delete, by a known method, virtual machines that are designated by the VM deletion request and applicable L2SWs if there are virtual L2SWs that are not connected to any virtual machine (step S151). Then, the processing returns to the calling source processing.

Incidentally, when it is determined at the step S141 that no virtual L2SWs will be deleted, there is no need to change the VLAN-ID assignments, and the processing moves to the step S147.

In this way, because there are cases in which the status of the subnets changes due to the deletion of the virtual machine, it becomes possible to appropriately judge, for each subnet, which is preferable among the VLAN mode and address conversion mode.

Next, the processing for the broadcast transfer amount change notification is explained using FIG. 30. First, the message controller 202 instructs the logical resource manager 205 to update the broadcast transfer amount per unit time for the subnet of the virtual L2SW that is the transmission source of the broadcast transfer amount change notification according to the notification (step S161). Incidentally, because the virtual L2SWs that belong to the same subnet transmit the broadcast transfer amount change notification in the same way, this step and subsequent processing are carried out for just the first notification.

Then, the message controller 202 causes the logical resource manager 205 to carry out a VLAN-ID assignment determination processing (step S163). The processing in FIG. 28 is performed.

After that, the message controller 202 causes the tenant manager 206 to update the data in the tenant data storage unit 210 (step S165). The tenant manager 206 updates data such as illustrated in FIG. 19 according to the VLAN-ID assignment state received from the message controller 202.

Furthermore, the message controller 202 generates, for each affected virtual L2SW, a control message, which includes as table update data, VLAN-ID received from the logical resource manager 205 in the case of the VLAN mode, and data representing the address conversion mode in the case of the address conversion mode, and causes the communication IF 201 to transmit the generated control message (step S167). By doing so, each affected virtual L2SW updates the conversion table storage area 108. After carrying out such a processing, the processing returns to the calling source processing.

In this way, when the number of times that the broadcast message is transmitted rapidly increases or decreases, a VLAN-ID is assigned to a suitable subnet that can reduce the processing load, so it is possible to reduce the processing load of the overall system.

Although embodiments of this technique are described, this technique is not limited to these embodiments. For example, the functional block diagrams do not always correspond to actual program module configurations. Furthermore, as for the processing flow, as long as the processing results do not change, the execution order may be exchanged and the steps may be executed in parallel.

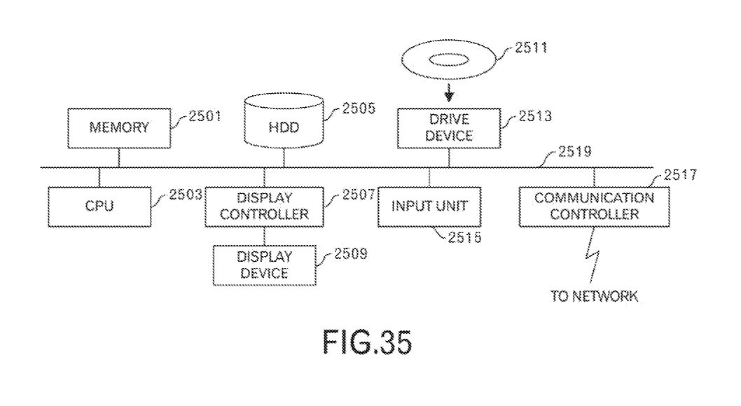

In addition, the resource management apparatus 200 and the physical server are a computer device as shown in FIG. 35. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 35. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The virtual machines and virtual L2SWs are activated based on data stored in the HDD 2505 or memory 2501 of the physical server or based on data transmitted from the resource management apparatus 200. The virtual machines and virtual L2SWs are virtual devices realized by programs for those and the hardware such as the processor 2503 and the like.

The aforementioned embodiments are outlined as follows:

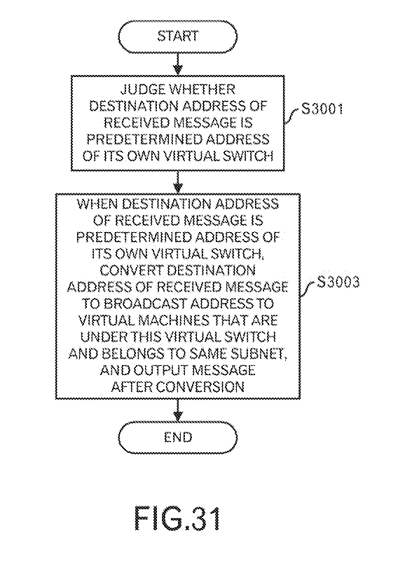

A program (FIG. 31), which relates to a first aspect of the embodiments, for a virtual switch on a computer, causes a computer to execute a procedure including: judging (S3001 in FIG. 31) whether or not a destination address of a received message is a predetermined address (which may be stored in a predetermined data storage area) of a first virtual switch; when it is judged that the destination address of the received message is the predetermined address of the first virtual switch, converting (S3003 in FIG. 31) the destination address of the received message to a broadcast address to virtual machines that are under the first virtual switch and belong to the same subnet, and outputting a message after the conversion.

By introducing such a program for a virtual switch, it becomes possible to prevent from outputting the broadcast message to other subnets, without using VLAN.

In addition, the procedure of the program relating to the first aspect may further include: receiving a broadcast message from one of the virtual machines; judging which is currently set in the first virtual switch among a Virtual Local Area Network (VLAN) mode and an address conversion mode; upon judging that the address conversion mode is set, converting a destination address of the received broadcast message to a predetermined address of another virtual switch belonging to the same subnet as a subnet to which the first virtual switch belongs, and outputting a message after the conversion to the predetermined address of another virtual switch; and upon judging that the VLAN mode is set, attaching a VLAN identifier of a subnet, to which the virtual machines belong, to the broadcast message, and outputting the broadcast message with the VLAN identifier to an upper-level communication apparatus or an upper-level virtual switch.

Thus, it is possible to switch the mode between the address conversion mode and VLAN mode, dynamically.

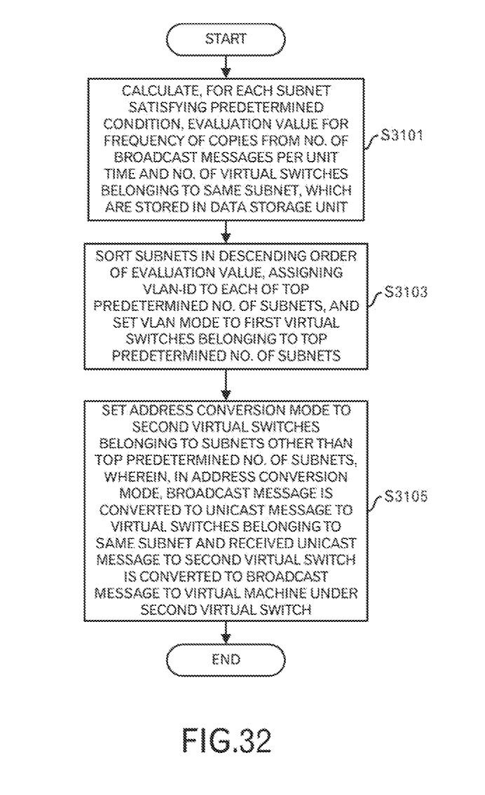

A mode setting method (FIG. 32) relating to a second aspect of the embodiments includes: (A) calculating (S3101 in FIG. 32), for each of subnets satisfying a predetermined condition, an evaluation value for the frequency of copies from the number of broadcast messages within unit time and the number of virtual switches belonging to the same subnet, which are stored in a data storage unit; (B) sorting (S3103 in FIG. 32) the subnets in descending order of the evaluation value, assigning an identifier of a virtual local area network (VLAN) to each of a top predetermined number of subnets, and setting a VLAN mode to first virtual switches belonging to the top predetermined number of subnets; and (C) setting (S3105 in FIG. 32) an address conversion mode to second virtual switches belonging to subnets other than the top predetermined number of subnets, wherein, in the address conversion mode, a broadcast message is converted to a unicast message to virtual switches belonging to the same subnet and a received unicast message to the second virtual switch is converted to a broadcast message to virtual machines under the second virtual switch.

By carrying out such a processing, even when there are a lot of subnets whose number exceeds the maximum number (e.g. 4096) of VLAN-IDs, it is possible to handle the broadcast messages in an appropriate form while reducing the processing load in the overall system

Incidentally, the aforementioned calculating, the sorting, assigning and setting and the setting may be executed upon detecting that the number of broadcast messages per unit time was changed so as to exceed a predetermined reference, or upon detecting that the number of virtual switches belonging to the same subnet was changed. Thus, it becomes possible to optimize the VLAN-ID assignment depending on the status change of the subnets.

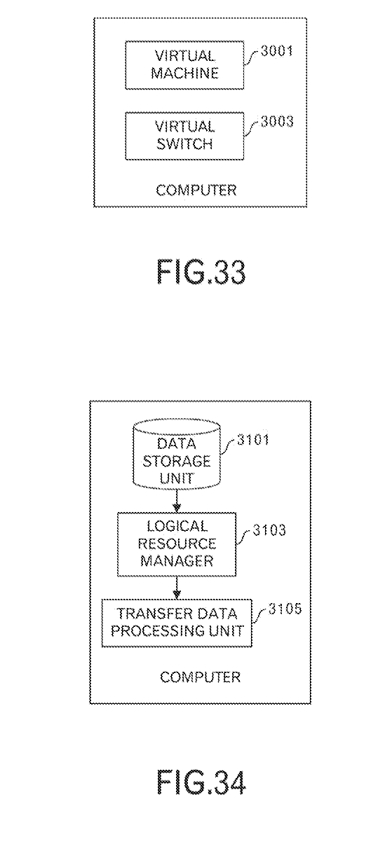

A computer (FIG. 33) relating to a third aspect of the embodiments executes a virtual machine (3001 in FIG. 33) and a virtual switch (3003 in FIG. 33). Then, the aforementioned virtual switch judges whether or not a destination address of a received message is a predetermined address of the virtual switch. Upon judging that the destination address of the received message is the predetermined address of the virtual switch, the virtual switch converts the destination address of the received message to a broadcast address to virtual machines that are under the virtual switch and belong to the same subnet as a subnet to which the virtual switch belongs. Then, the virtual switch outputs a message after the conversion.

Furthermore, a computer (FIG. 34) relating to a fourth aspect of the embodiments, includes: a logical resource manager (3103 in FIG. 34) to calculate, for each of subnets satisfying a predetermined condition, an evaluation value for the frequency of copies from the number of broadcast messages per unit time and the number of virtual switches belonging to a same subnet, which are stored in a data storage unit (3101 in FIG. 34), to sort the subnets in descending order of the evaluation value, to assign an identifier of a virtual local area network (VLAN) to each of a top predetermined number of subnets, and to set a VLAN mode to first virtual switches belonging to the top predetermined number of subnets; and a transfer data processing unit (3105 in FIG. 34) to set an address conversion mode to second virtual switches belonging to subnets other than the top predetermined number of subnets, wherein, in the address conversion mode, a broadcast message is converted to a unicast message to virtual switches belonging to the same subnet and a received unicast message to the second virtual switch is converted to a broadcast message to virtual machines under the second virtual switch.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory medium storing a program for a virtual switch on a computer, wherein said program causes said computer to execute a procedure, the procedure comprises:
judging whether or not a destination address of a received message is a predetermined address of a first virtual switch being operating;
upon judging that the destination address of the received message is the predetermined address of the first virtual switch, converting the destination address of the received message to a broadcast address to virtual machines that are under the first virtual switch and belong to the same subnet as a subnet to which the first virtual switch belongs; and
outputting a message after the conversion.

2. The computer-readable, non-transitory medium as set forth in claim 1, wherein the procedure further comprises:
receiving a broadcast message from one of the virtual machines;
judging which is currently set in the first virtual switch among a Virtual Local Area Network (VLAN) mode and an address conversion mode;
upon judging that the address conversion mode is set, converting a destination address of the received broadcast message to a predetermined address of another virtual switch belonging to the same subnet as a subnet to which the first virtual switch belongs, and outputting a message after the conversion to the predetermined address of another virtual switch; and
upon judging that the VLAN mode is set, attaching a VLAN identifier of a subnet to which the virtual machines belong to the broadcast message, and outputting the broadcast message with the VLAN identifier to an upper-level communication apparatus or an upper-level virtual switch.

3. A computer-readable, non-transitory medium storing a program for causing a computer to execute a procedure, said procedure comprising:
calculating, for each of subnets satisfying a predetermined condition, an evaluation value for frequency of copies from the number of broadcast messages per unit time and the number of virtual switches belonging to a same subnet, which are stored in a data storage unit;
sorting the subnets in descending order of the evaluation value, assigning an identifier of a virtual local area network (VLAN) to each of a top predetermined number of subnets, and setting a VLAN mode to first virtual switches belonging to the top predetermined number of subnets; and
setting an address conversion mode to second virtual switches belonging to subnets other than the top predetermined number of subnets, wherein, in the address conversion mode, a broadcast message is converted to a unicast message to virtual switches belonging to the same subnet and a received unicast message to the second virtual switch is converted to a broadcast message to virtual machines under the second virtual switch.

4. The computer-readable, non-transitory medium as set forth in claim 3, wherein the calculating, the sorting, assigning and setting and the setting are executed upon detecting that the number of broadcast messages per unit time was changed so as to exceed a predetermined reference, or upon detecting that the number of virtual switches belonging to the same subnet was changed.

5. A computer comprising:
a memory; and
a processor using the memory, and
wherein the processor is capable of executing a virtual machine and a virtual switch, and
the virtual switch judges whether or not a destination address of a received message is a predetermined address of the virtual switch,
upon judging that the destination address of the received message is the predetermined address of the virtual switch, the virtual switch converts the destination address of the received message to a broadcast address to virtual machines that are under the virtual switch and belong to the same subnet as a subnet to which the virtual switch belongs, and
the virtual switch outputs a message after the conversion.

6. A computer comprising:
a data storage unit;
a logical resource manager to calculate, for each of subnets satisfying a predetermined condition, an evaluation value for frequency of copies from the number of broadcast messages per unit time and the number of virtual switches belonging to a same subnet, which are stored in the data storage unit, to sort the subnets in descending order of the evaluation value, to assign an identifier of a virtual local area network (VLAN) to each of a top predetermined number of subnets, and to set a VLAN mode to first virtual switches belonging to the top predetermined number of subnets; and
a transfer data processing unit to set an address conversion mode to second virtual switches belonging to subnets other than the top predetermined number of subnets, wherein, in the address conversion mode, a broadcast message is converted to a unicast message to virtual switches belonging to the same subnet and a received unicast message to the second virtual switch is converted to a broadcast message to virtual machines under the second virtual switch.
